(19) United States
(12) Patent Application Publication
(10) Pub. No.: US 2021/0223617 A1
(43) Pub. Date: Jul. 22, 2021

(54) COLOR FILTER SUBSTRATE AND MANUFACTURING METHOD THEREOF

(71) Applicant: SHENZHEN CHINA STAR OPTOELECTRONICS TECHNOLOGY CO., LTD., Shenzhen, Guangdong (CN)

(72) Inventors: Xulin LIN, Shenzhen, Guangdong (CN); Lixuan CHEN, Shenzhen, Guangdong (CN)

(21) Appl. No.: 16/304,496

(22) PCT Filed: May 7, 2018
(86) PCT No.: PCT/CN2018/085846

§ 371 Date: Nov. 26, 2018

(30) Foreign Application Priority Data
Apr. 11, 2018 (CN) 201810318327.1

(51) Int. Cl. G02F 1/1335; G02F 1/1333; G02F 1/1343

(52) U.S. Cl. CPC G02F 1/133516; G02F 1/134309; G02F 1/133357; G02F 1/133512

(57) ABSTRACT

Disclosed are a color filter substrate and a manufacturing method thereof. The color filter substrate includes a substrate, a color filter layer, a light shielding layer and a common electrode layer. The color filter layer includes a red color block, a green color block and a blue color block. The light shielding layer is disposed on the color filter layer. The light shielding layer includes light shielding blocks. The common electrode layer is disposed on the light shielding layer. Positions of intersections between any two of the red color block, the green color block and the blue color block correspond to positions of the light shielding blocks. A reflection intensity of ambient light from a liquid crystal display panel can be effectively reduced.

### FIELD OF THE INVENTION

The present invention relates to a display field, and more particularly to a color filter substrate and a manufacturing method thereof.

### BACKGROUND OF THE INVENTION

The liquid crystal display panel partially reflects external ambient light emitted to the liquid crystal display panel. The reflection of the external ambient light by the liquid crystal display panel will reduce the contrast of the image shown by the liquid crystal display panel and the visibility of the shown content in a strong light environment. Therefore, reducing the reflection of the external ambient light from the liquid crystal display panel helps to enhance the display effect.

For solving the aforesaid technical issue, a conventional technical solution is: utilizing a low reflectivity polarizer to reduce the reflectivity of the surface of the liquid crystal display panel.

However, the color filter substrate of the conventional liquid crystal display panel is disposed with a light shielding layer. The light shielding layer is also called BM (Black Matrix). The light shielding layer constitutes a non-aperture area of a sub pixel unit of the conventional liquid crystal display panel to shield the edge area and the TFT (Thin Film Transistor) area of the sub pixel unit to avoid the dark-state light leakage. Although the light transmittance of the light shielding layer is very small (less than 0.01%), the light reflectivity thereof (2% to 3%) cannot be ignored. Besides, the area of the light shielding layer in one sub pixel unit usually reaches 20% to 30%. Thus, reducing the reflectivity of the light shielding layer to the ambient light possesses a significant effect on reducing the overall ambient light reflectivity of the conventional liquid crystal display panel.

In the color filter substrate of the conventional liquid crystal display panel, the light shielding layer is closely attached to the glass substrate and the color filter layer is above the light shielding layer. Since the light shielding layer is closely attached to the glass substrate, the incident external ambient light is reflected at the interface of the glass substrate and the light shielding layer.

Therefore, the foregoing technical solution of reducing the reflection of the external ambient light by the liquid crystal display panel is not ideal enough.

Consequently, there is a need to provide a new technical solution for solving the aforesaid technical problem.

### SUMMARY OF THE INVENTION

An objective of the present invention is to provide a color filter substrate and a manufacturing method thereof, which can effectively reduce reflection of a light shielding layer of a liquid crystal display panel to external ambient light.

To solve the aforesaid problem, the technical solution of the present invention is described as follows:

a color filter substrate, including: a substrate; a color filter layer, disposed on the substrate, wherein the color filter layer includes a first color block, a second color block and a third color block, and the first color block, the second color block and the third color block are different color blocks in a red color block, a green color block and a blue color block; a light shielding layer, disposed on the color filter layer, wherein the light shielding layer includes light shielding blocks; a common electrode layer, disposed on the light shielding layer; wherein positions of intersections between any two of the red color block, the green color block and the blue color block correspond to positions of the light shielding blocks; the color filter layer disposed between the substrate and the light shielding layer reduces a reflection intensity of ambient light from an area covered by the light shielding layer in the color filter substrate; a surface of the color filter layer is an uneven surface; wherein the color filter substrate further includes: a planarization layer, disposed between the color filter layer and the light shielding layer, wherein the planarization layer covers the uneven surface of the color filter layer for the light shielding layer to be disposed on a planar surface; a surface of the color filter substrate is a planar surface, wherein the common electrode layer is further disposed on the color filter substrate.

In the aforesaid color filter substrate, the common electrode layer is further disposed on the planarization layer.

A color filter substrate, including: a substrate; a color filter layer, disposed on the substrate, wherein the color filter layer includes a first color block, a second color block and a third color block, and the first color block, the second color block and the third color block are different color blocks in a red color block, a green color block and a blue color block; a light shielding layer, disposed on the color filter layer, wherein the light shielding layer includes light shielding blocks; a common electrode layer, disposed on the light shielding layer; wherein positions of intersections between any two of the red color block, the green color block and the blue color block correspond to positions of the light shielding blocks.

In the aforesaid color filter substrate, the color filter layer disposed between the substrate and the light shielding layer reduces a reflection intensity of ambient light from an area covered by the light shielding layer in the color filter substrate.

In the aforesaid color filter substrate, a surface of the color filter layer is an uneven surface; wherein the color filter substrate further includes: a planarization layer, disposed between the color filter layer and the light shielding layer, wherein the planarization layer covers the uneven surface of the color filter layer for the light shielding layer to be disposed on a planar surface.

In the aforesaid color filter substrate, the common electrode layer is further disposed on the planarization layer.

In the aforesaid color filter substrate, a surface of the color filter substrate is a planar surface, wherein the common electrode layer is further disposed on the color filter substrate.

In the aforesaid color filter substrate, the intersections between any two of the first color block, the second color block and the third color block shield or absorb light from a side of the substrate away from the color filter layer, which passes through the substrate and emits to the light shielding block, to prevent the light from being reflected at the intersections between any two of the first color block, the second color block and the third color block.

In the aforesaid color filter substrate, edges of any two of the first color block, the second color block and the third color block are completely overlapped or partially overlapped.

In the aforesaid color filter substrate, an overlapped portion of any two of the first color block, the second color block and the third color block constitute a light block, and the light block blocks light of any one of the first color block, the second color block and the third color block emitted to another block adjacent thereto.

In the aforesaid color filter substrate, an edge of any one of the first color block, the second color block and the third color block and an edge of another block adjacent thereto are respectively provided with a first engaged part and a second engaged part, and the first engaged part and the second engaged part are engaged with each other.

A manufacturing method of a color filter substrate, including steps of: Step A, disposing a color filter layer on a substrate, wherein the color filter layer includes a first color block, a second color block and a third color block, and the first color block, the second color block and the third color block are different color blocks in a red color block, a green color block and a blue color block; Step B, disposing a light shielding layer on the color filter layer, wherein the light shielding layer includes light shielding blocks; Step C, disposing a common electrode layer on the light shielding layer; wherein positions of intersections between any two of the red color block, the green color block and the blue color block correspond to positions of the light shielding blocks.

In the aforesaid manufacturing method of the color filter substrate, the color filter layer disposed between the substrate and the light shielding layer reduces a reflection intensity of ambient light from an area covered by the light shielding layer in the color filter substrate.

In the aforesaid manufacturing method of the color filter substrate, a surface of the color filter layer is an uneven surface; wherein after Step A and before Step B, the manufacturing method further includes a step of: Step D, disposing a planarization layer between the color filter layer and the light shielding layer, wherein the planarization layer covers the uneven surface of the color filter layer for the light shielding layer to be disposed on a planar surface; disposing the light shielding layer on the planarization layer, which is disposed on the color filter layer.

In the aforesaid manufacturing method of the color filter substrate, the common electrode layer is further disposed on the planarization layer.

In the aforesaid manufacturing method of the color filter substrate, a surface of the color filter substrate is a planar surface, wherein the common electrode layer is further disposed on the color filter substrate.

In the aforesaid manufacturing method of the color filter substrate, the intersections between any two of the first color block, the second color block and the third color block shield or absorb light from a side of the substrate away from the color filter layer, which passes through the substrate and emits to the light shielding block, to prevent the light from being reflected at the intersections between any two of the first color block, the second color block and the third color block.

In the aforesaid manufacturing method of the color filter substrate, edges of any two of the first color block, the second color block and the third color block are completely overlapped or partially overlapped.

In the aforesaid manufacturing method of the color filter substrate, an overlapped portion of any two of the first color block, the second color block and the third color block constitute a light block, and the light block blocks light of any one of the first color block, the second color block and the third color block emitted to another block adjacent thereto.

In the aforesaid manufacturing method of the color filter substrate, an edge of any one of the first color block, the second color block and the third color block and an edge of another block adjacent thereto are respectively provided with a first engaged part and a second engaged part, and the first engaged part and the second engaged part are engaged with each other.

Compared to the prior art, the color filter layer is disposed between the substrate and the light shielding layer in the present invention. Since the color filter layer absorbs the external light, the reflection intensity of ambient light from the area covered by the light shielding layer in the color filter substrate can be effectively reduced. Thus, the reflectivity of the liquid crystal display panel to the external ambient light can be effectively reduced.

For a better understanding of the aforementioned content of the present invention, preferable embodiments are illustrated in accordance with the attached figures for further explanation.

### BRIEF DESCRIPTION OF THE DRAWINGS

FIG. 1 is a diagram of the first embodiment of a color filter substrate according to the present invention.

FIG. 2 is a diagram of the second embodiment of a color filter substrate according to the present invention.

FIG. 3 is a flowchart of a manufacturing method of a color filter substrate according to the present invention.

### DETAILED DESCRIPTION OF PREFERRED EMBODIMENTS

The word, “an embodiment” used in this specification means serving as an example, an instance, or an illustration. Besides, in this specification and the appended claims, the articles “a” generally means “one or more” unless specified otherwise or the singular form can be clearly confirmed in the context.

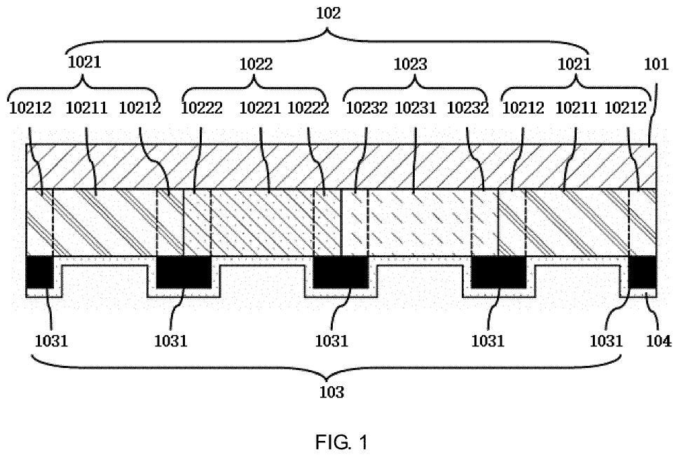

Please refer to FIG. 1. FIG. 1 is a diagram of the first embodiment of a color filter substrate according to the present invention. The color filter substrate of the present invention is applied for a TFT-LCD (Thin Film Transistor Liquid Crystal Display).

The color filter substrate of the present invention includes a substrate 101, a color filter layer 102, a light shielding layer 103 and a common electrode layer 104. The substrate 101 is a rigid substrate or a flexible substrate.

The color filter layer 102 is disposed on the substrate 101. The color filter layer 102 includes a first color block 1021, a second color block 1022 and a third color block 1023, and the first color block 1021, the second color block 1022 and the third color block 1023 are different color blocks in a red color block, a green color block and a blue color block. Each of the first color block 1021, the second color block 1022 and the third color block 1023 includes a main body and an edge. Any one of the first color block 1021, the second color block 1022 and the third color block 1023 is next to another one with its edge. Both the main body and the edge are closely attached to the substrate 101.

The light shielding layer 103 is disposed on the color filter layer 102. The light shielding layer 103 includes light shielding blocks 1031.

The common electrode layer 104 is disposed on the light shielding layer 103.

Positions of intersections between any two of the red color block, the green color block and the blue color block correspond to positions of the light shielding blocks 1031.

The color filter layer 102 disposed between the substrate 101 and the light shielding layer 103 reduces a reflection intensity of ambient light from an area covered by the light shielding layer 103 in the color filter substrate 102. Namely, the color filter layer 102 is used to prevent the substrate 101 and the light shielding layer 103 from forming a mirror.

A surface of the color filter layer 102 is a planar surface and the common electrode layer 104 is further disposed on the color filter layer 102. Namely, the common electrode is disposed on the color filter layer 102 and the light shielding layer 103.

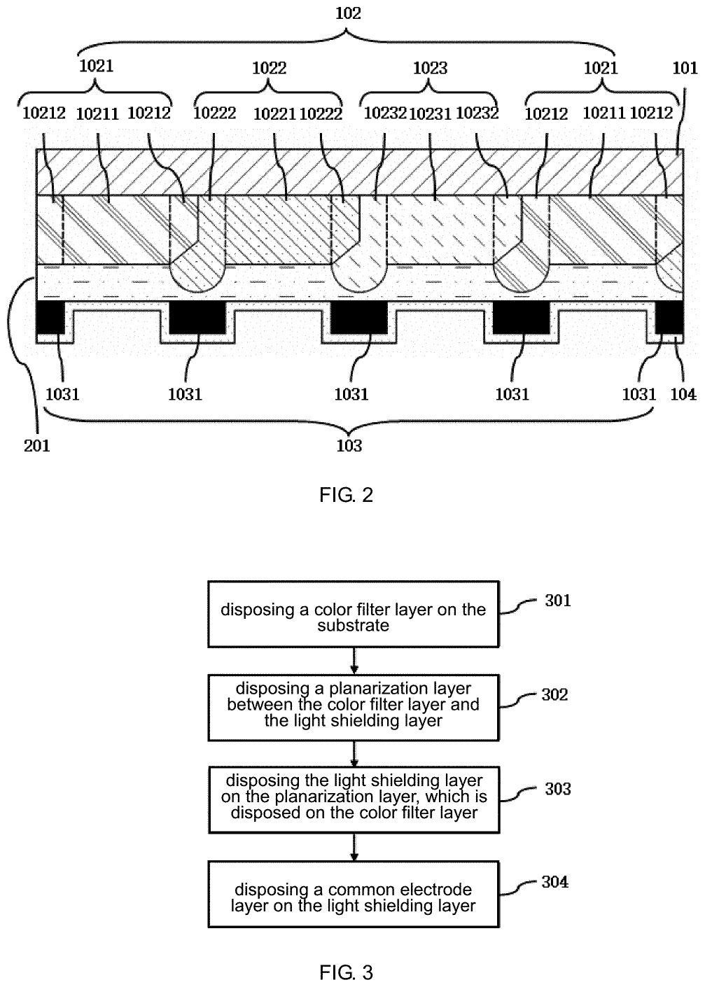

Please refer to FIG. 2. FIG. 2 is a diagram of the second embodiment of a color filter substrate according to the present invention. The second embodiment of the present invention is similar to the first embodiment as aforementioned. The difference is:

A surface of the color filter layer 102 is an uneven surface.

The color filter substrate further includes a planarization layer 201. The planarization layer 201 is disposed between the color filter layer 102 and the light shielding layer 103. The planarization layer 201 covers the uneven surface of the color filter layer 102 for the light shielding layer 103 to be disposed on a planar surface. The planarization layer 201 is configured to be completely transparent or translucent.

The common electrode layer 104 is further disposed on the planarization layer 201. Namely, the common electrode layer 104 is further disposed on the planarization layer 201 and the light shielding layer 103.

The first color block 1021, the second color block 1022 and the third color block 1023 are sequentially disposed on the substrate 101.

The intersections between any two of the first color block 1021, the second color block 1022 and the third color block 1023 shield or absorb light from a side of the substrate 101 away from the color filter layer 102, which passes through the substrate 101 and emits to the light shielding block 1031, to prevent the light from being reflected at the intersections between any two of the first color block 1021, the second color block 1022 and the third color block 1023.

Edges of any two of the first color block 1021, the second color block 1022 and the third color block 1023 are completely overlapped or partially overlapped.

An overlapped portion of any two of the first color block 1021, the second color block 1022 and the third color block 1023 constitute a light block. The light block blocks light of any one of the first color block 1021, the second color block 1022 and the third color block 1023 emitted to another block adjacent thereto.

An edge of any one of the first color block 1021, the second color block 1022 and the third color block 1023 and an edge of another block adjacent thereto are respectively provided with a first engaged part and a second engaged part, and the first engaged part and the second engaged part are engaged with each other.

One of the first engaged part and the second engaged part is a groove and the other of the first engaged part and the second engaged part is a ridge.

As an improvement, an area of the substrate 101 in contact with color filter layer 102, corresponding to the light shielding layer 103 is arranged to be an abrasive surface, i.e. the area is arranged to be not smooth. The area arranged to be the abrasive surface is used to diffusely reflect the external ambient light emitted to the area, thus to effectively reduce the reflectivity of the liquid crystal display panel having the color filter substrate to the external ambient light. Besides, the area arranged to be the abrasive surface is also used to enhance the adhesion strength between the color filter layer 102 and the substrate 101.

Please refer to FIG. 3. FIG. 3 is a flowchart of a manufacturing method of a color filter substrate according to the present invention.

The manufacturing method of the color filter substrate according to the present invention includes steps of:

Step A (Step 301), disposing a color filter layer 102 on the substrate 101, wherein the color filter layer 102 includes a first color block 1021, a second color block 1022 and a third color block 1023, and the first color block 1021, the second color block 1022 and the third color block 1023 are different color blocks in a red color block, a green color block and a blue color block. Each of the first color block 1021, the second color block 1022 and the third color block 1023 includes a main body and an edge. Any one of the first color block 1021, the second color block 1022 and the third color block 1023 is next to another one with its edge. Both the main body and the edge are closely attached to the substrate 101.

Step B (Step 303), disposing a light shielding layer 103 on the color filter layer 102, wherein the light shielding layer 103 includes light shielding blocks 1031.

Step C (Step 304), disposing a common electrode layer 104 on the light shielding layer 103.

Positions of intersections between any two of the red color block, the green color block and the blue color block correspond to positions of the light shielding blocks 1031.

The color filter layer 102 disposed between the substrate 101 and the light shielding layer 103 reduces a reflection intensity of ambient light from an area covered by the light shielding layer 103 in the color filter substrate 102. Namely, the color filter layer 102 is used to prevent the substrate 101 and the light shielding layer 103 from forming a mirror.

In a condition that a surface of the color filter layer 102 is a planar surface, the common electrode layer 104 is further disposed on the color filter layer 102. Namely, the common electrode is disposed on the color filter layer 102 and the light shielding layer 103.

In a condition that a surface of the color filter layer 102 is an uneven surface, after Step A and before Step B, the manufacturing method further includes a step of:

Step D (Step 302), disposing a planarization layer 201 between the color filter layer 102 and the light shielding layer 103, wherein the planarization layer 201 covers the uneven surface of the color filter layer 102 for the light shielding layer 103 to be disposed on a planar surface.

Step B is: disposing the light shielding layer 103 on the planarization layer 201 that is disposed on the color filter layer 102.

The common electrode layer 104 is further disposed on the planarization layer 201. Namely, the common electrode layer 104 is further disposed on the planarization layer 201 and the light shielding layer 103.

Step A includes:

Step a1, disposing the first color block 1021 on the substrate 101.

Step a2, disposing the second color block 1022 on the substrate 101 except for a position where the first color block 1021 is disposed.

Step a3, disposing the third color block 1023 on the substrate 101 except for positions where the first color block 1021 and the second color block 1022 are disposed.

The intersections between any two of the first color block 1021, the second color block 1022 and the third color block 1023 shield or absorb light from a side of the substrate 101 away from the color filter layer 102, which passes through the substrate 101 and emits to the light shielding block 1031, to prevent the light from being reflected at the intersections between any two of the first color block 1021, the second color block 1022 and the third color block 1023.

Edges of any two of the first color block 1021, the second color block 1022 and the third color block 1023 are completely overlapped or partially overlapped.

An overlapped portion of any two of the first color block 1021, the second color block 1022 and the third color block 1023 constitute a light block. The light block blocks light of any one of the first color block 1021, the second color block 1022 and the third color block 1023 emitted to another block adjacent thereto.

An edge of any one of the first color block 1021, the second color block 1022 and the third color block 1023 and an edge of another block adjacent thereto are respectively provided with a first engaged part and a second engaged part, and the first engaged part and the second engaged part are engaged with each other.

One of the first engaged part and the second engaged part is a groove and the other of the first engaged part and the second engaged part is a ridge.

As an improvement, before Step a1, Step A further includes:

Step a4, arranging an area of the substrate 101 in contact with color filter layer 102, corresponding to the light shielding layer 103 to be an abrasive surface, i.e. arranging the area to be not smooth. The area arranged to be the abrasive surface is used to diffusely reflect the external ambient light emitted to the area, thus to effectively reduce the reflectivity of the liquid crystal display panel having the color filter substrate to the external ambient light. Besides, the area arranged to be the abrasive surface is also used to enhance the adhesion strength between the color filter layer 102 and the substrate 101.

Compared to the prior art, the color filter layer is disposed between the substrate and the light shielding layer in the present invention. Since the color filter layer absorbs the external light, the direct contact between the light shielding layer and the substrate can be avoided to effectively reduce the reflection intensity of ambient light from the area (non-aperture area) covered by the light shielding layer in the color filter substrate. The substrate and the light shielding layer in direct contact with the substrate are prevented from composing a device having a higher reflective efficiency to effectively reduce the reflectivity of the liquid crystal display panel having the color filter substrate to the external ambient light.

In summary, although the above preferred embodiments of the present invention are disclosed, the foregoing preferred embodiments are not intended to limit the invention, those skilled in the art can make various kinds of alterations and modifications without departing from the spirit and scope of the present invention. Thus, the scope of protection of the present invention is defined by the scope of the claims.

What is claimed is:

1. A color filter substrate, comprising:
a substrate;
a color filter layer, disposed on the substrate, wherein the color filter layer comprises a first color block, a second color block and a third color block, and the first color block, the second color block and the third color block are different color blocks in a red color block, a green color block and a blue color block;
a light shielding layer, disposed on the color filter layer, wherein the light shielding layer comprises light shielding blocks;
a common electrode layer, disposed on the light shielding layer;
wherein positions of intersections between any two of the red color block, the green color block and the blue color block correspond to positions of the light shielding blocks;
the color filter layer disposed between the substrate and the light shielding layer reduces a reflection intensity of ambient light from an area covered by the light shielding layer in the color filter substrate;
a surface of the color filter layer is an uneven surface;
wherein the color filter substrate further comprises:
a planarization layer, disposed between the color filter layer and the light shielding layer, wherein the planarization layer covers the uneven surface of the color filter layer for the light shielding layer to be disposed on a planar surface;
a surface of the color filter substrate is a planar surface, wherein the common electrode layer is further disposed on the color filter substrate.

2. The color filter substrate according to claim 1, wherein the common electrode layer is further disposed on the planarization layer.

3. A color filter substrate, comprising:
a substrate;
a color filter layer, disposed on the substrate, wherein the color filter layer comprises a first color block, a second color block and a third color block, and the first color block, the second color block and the third color block are different color blocks in a red color block, a green color block and a blue color block;
a light shielding layer, disposed on the color filter layer, wherein the light shielding layer comprises light shielding blocks;
a common electrode layer, disposed on the light shielding layer;
wherein positions of intersections between any two of the red color block, the green color block and the blue color block correspond to positions of the light shielding blocks.

4. The color filter substrate according to claim 3, wherein the color filter layer disposed between the substrate and the light shielding layer reduces a reflection intensity of ambient light from an area covered by the light shielding layer in the color filter substrate.

5. The color filter substrate according to claim 3, wherein a surface of the color filter layer is an uneven surface;
wherein the color filter substrate further comprises:
a planarization layer, disposed between the color filter layer and the light shielding layer, wherein the planarization layer covers the uneven surface of the color filter layer for the light shielding layer to be disposed on a planar surface.

6. The color filter substrate according to claim 5, wherein the common electrode layer is further disposed on the planarization layer.

7. The color filter substrate according to claim 3, wherein a surface of the color filter substrate is a planar surface, wherein the common electrode layer is further disposed on the color filter substrate.

8. The color filter substrate according to claim 3, wherein the intersections between any two of the first color block, the second color block and the third color block shield or absorb light from a side of the substrate away from the color filter layer, which passes through the substrate and emits to the light shielding block, to prevent the light from being reflected at the intersections between any two of the first color block, the second color block and the third color block.

9. The color filter substrate according to claim 3, wherein edges of any two of the first color block, the second color block and the third color block are completely overlapped or partially overlapped.

10. The color filter substrate according to claim 3, wherein an overlapped portion of any two of the first color block, the second color block and the third color block constitute a light block, and the light block blocks light of any one of the first color block, the second color block and the third color block emitted to another block adjacent thereto.

11. The color filter substrate according to claim 3, wherein an edge of any one of the first color block, the second color block and the third color block and an edge of another block adjacent thereto are respectively provided with a first engaged part and a second engaged part, and the first engaged part and the second engaged part are engaged with each other.

12. A manufacturing method of a color filter substrate, comprising steps of:
Step A, disposing a color filter layer on a substrate, wherein the color filter layer comprises a first color block, a second color block and a third color block, and the first color block, the second color block and the third color block are different color blocks in a red color block, a green color block and a blue color block;
Step B, disposing a light shielding layer on the color filter layer, wherein the light shielding layer comprises light shielding blocks;
Step C, disposing a common electrode layer on the light shielding layer;
wherein positions of intersections between any two of the red color block, the green color block and the blue color block correspond to positions of the light shielding blocks.

13. The manufacturing method of the color filter substrate according to claim 12, wherein the color filter layer disposed between the substrate and the light shielding layer reduces a reflection intensity of ambient light from an area covered by the light shielding layer in the color filter substrate.

14. The manufacturing method of the color filter substrate according to claim 12, wherein a surface of the color filter layer is an uneven surface;
wherein after Step A and before Step B, the manufacturing method further comprises a step of:
Step D, disposing a planarization layer between the color filter layer and the light shielding layer, wherein the planarization layer covers the uneven surface of the color filter layer for the light shielding layer to be disposed on a planar surface;
Step B is:
disposing the light shielding layer on the planarization layer, which is disposed on the color filter layer.

15. The manufacturing method of the color filter substrate according to claim 14, wherein the common electrode layer is further disposed on the planarization layer.

16. The manufacturing method of the color filter substrate according to claim 12, wherein a surface of the color filter substrate is a planar surface, wherein the common electrode layer is further disposed on the color filter substrate.

17. The manufacturing method of the color filter substrate according to claim 12, wherein the intersections between any two of the first color block, the second color block and the third color block shield or absorb light from a side of the substrate away from the color filter layer, which passes through the substrate and emits to the light shielding block, to prevent the light from being reflected at the intersections between any two of the first color block, the second color block and the third color block.

18. The manufacturing method of the color filter substrate according to claim 12, wherein edges of any two of the first color block, the second color block and the third color block are completely overlapped or partially overlapped.

19. The manufacturing method of the color filter substrate according to claim 12, wherein an overlapped portion of any two of the first color block, the second color block and the third color block constitute a light block, and the light block blocks light of any one of the first color block, the second color block and the third color block emitted to another block adjacent thereto.

20. The manufacturing method of the color filter substrate according to claim 12, wherein an edge of any one of the first color block, the second color block and the third color block and an edge of another block adjacent thereto are respectively provided with a first engaged part and a second engaged part, and the first engaged part and the second engaged part are engaged with each other.
